(19) United States
(12) Patent Application Publication
(10) Pub. No.: US 2002/0000727 A1
(43) Pub. Date: Jan. 3, 2002

(54) Vehicle lock, in particular for a tailgate door

(76) Inventors: Focke Rass, Bremen (DE); Michael Kusen, Bremen (DE)

Correspondence Address: EVENSON, McKEOWN, EDWARDS & LENAHAN, P.L.L.C., Suite 700, 1200 G Street, N.W., Washington, DC, 20005, US

(21) Appl. No.: 09/835,063

(22) Filed: Apr. 16, 2001

(30) Foreign Application Priority Data
Apr. 14, 2000 (DE) 100 18 560.6

(51) Int. Cl. E05C 3/06

(52) U.S. Cl. 292/216

(57) ABSTRACT

A vehicle lock has a latching housing which can be fixed to a support or the body of the vehicle at a variable location, and a lock housing which can be introduced therein. Guide elements for latching wedges provided in the latching housing are composed of first and second rough- and fine-positioning guide elements. The first, rough-positioning guide means comprise a bore running in the latching direction within a latching wedge and a guide rod which engages axially in the bore and is fastened rigidly to the latching housing with guide play between the hole of a latching wedge and the associated guide rod. The second, fine-positioning guide elements in each case comprise a planar, inner guide surface of a side wall of the latching housing and a planar side surface of the particular latching wedge, which side surface is assigned to the particular guide surface. When the lock is closed, the amount of guide play in the first guide elements allow lateral positional fixing of the latching wedges between the lock housing and the latching housing solely by means of the second guide elements.

### BACKGROUND AND SUMMARY OF THE INVENTION

This application claims the priority of Germany patent document 100 18 560.6, filed Apr. 14, 2000, the disclosure of which is expressly incorporated by reference herein.

The invention relates to a vehicle lock of the type used in particular for a tailgate door.

In a vehicle lock of this type disclosed in European patent document EP 0 314 075 B1, the latching wedges are guided via tongue and groove elements. Thus, when the lock is latched in place malfunctions may occur due to the latching wedges tilting within the guide elements. Furthermore, in this known lock, the latching housing can be installed only in a state such that it is impossible to see into the interior once the lock housing has been introduced. This makes it difficult to compensate for tolerances with regard to the position of the lock housing during assembly of the latching housing.

One object of the present invention is to improve the functioning capability of the generic lock of the type described.

Another object of the invention is to improve the tolerance-compensating assembly of the latching housing.

These and other objects and advantages are achieved by the vehicle lock according to the invention, which is based on the general concept of mounting the latching wedges in such a manner that they are first roughly mounted and guided with play with the lock not yet closed, with precise lateral fixing being achieved by additional fine positioning. Such fine positioning is in turn achieved by a continuous spring pressure on the parts which are of trapezoidal design and bear against one another, ensuring that no transverse play can occur. The trapezoidal shape which is present means that under the prevailing spring pressure there is automatic separation between the parts bearing against one another.

Tolerance-compensating assembly of the latching housing is made possible by the fact that the latching housing can be installed in an open state. For this purpose, the latching housing is constructed so that its interior space is closed by a covering closed only after assembly. In order to be able to fit a covering of this type only after assembly of the latching housing, when the lock is closed, the abutment for securing the rotary latch is fitted solely on a baseplate of the latching housing.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a plan view of a lock which is approaching a closed state; and

FIG. 2 shows a broken away side view of the latching bracket along the line II-II in FIG. 1.

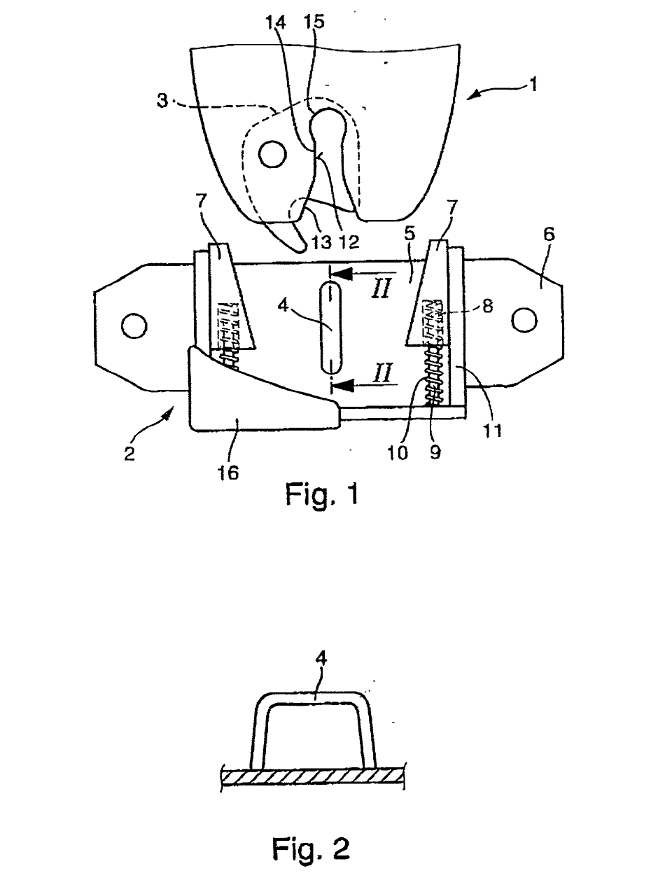

### DETAILED DESCRIPTION OF THE DRAWINGS

The vehicle lock comprises a lock housing 1 and a latching housing 2. When the lock is closed, the lock housing 1 is inserted into the latching housing 2. In this state, the lock housing 1 is latched in place on a latching bracket 4 of the latching housing 2 by means of a rotary latch 3 which is mounted in the lock housing. The latching bracket 4 is fastened on a baseplate 5 of the latching housing.

The lock housing 1 is located, for example, on a vehicle tailgate door, while the latching housing is fastened to the vehicle body. On the vehicle body, the baseplate 5 of the latching housing can be fixed in a roughly adjusted manner with respect to the position of the lock housing 1, as predetermined by the fitting of the tailgate door. Fixing of the baseplate 5 specifically takes place via fastening means which engage on lateral flanges 6 of the latching housing 2.

In the pivoting plane of the rotary latch 3 the lock housing 1 is of trapezoidal design at the sides.

Latching wedges 7 which are provided in the baseplate 5 of the latching housing 2, are mounted at the sides in such a manner that they are movable in the latching direction. The slope of the latching wedges 7 is matched to the trapezoidal shape of the lock housing 1 in such a manner that the side surfaces of the lock housing 1 can bear in a surface-locking manner against the latching wedges 7.

On the baseplate 5 of the latching housing 2 the latching wedges 7 have rough guides, i.e., guides having a relatively large amount of play therein. The guides comprise, per latching wedge 7, a bore 8 which runs in the latching direction within a latching wedge 7, and a guide rod 9 which is fastened to the baseplate 5 and engages in the hole 8 with radial play. The latching wedges 7 are spring-loaded in the direction of the latching housing 2 and counter to the latching direction of the lock housing 1, by means of helical springs 10 which are supported on the baseplate 5. The latching wedges 7 are secured against falling out or being taken out of the latching housing 2, for example by means of a fixed connection to the helical springs 10, which are in turn connected fixedly to the baseplate 5. However, other securing measures are also possible; for example, by means of stops in the latching housing 2.

The latching in place of the lock proceeds as follows.

When the lock housing 1 is introduced into the latching housing 2, the trapezoidal side edges of the lock housing 1 are placed against the associated latching wedges 7. If the lock housing 1 is positioned centrally with respect to the latching housing 2, on introduction of the lock housing 1 the two latching wedges 7 slide uniformly into the latching housing 2 under stressing of the helical springs 10. The rotary latch 3 latches the lock housing 1 in place in a known manner on the latching bracket 4 opposite the latching housing 2. Because of the spring biasing of the latching wedges 7, the latter each bear against one of the side surfaces of the lock housing 1 one side and against one of the side walls of the latching housing 2 at the other side. The surfaces at which the latching wedges 7 and the side walls of the latching housing 2 bear against one another, are in each case of planar design, the surface planes in each case running parallel to the latching direction. The latching wedges 7 obtain their fine positioning by their bearing against the side walls 11 of the latching housing 2. In order for fine positioning of this type to be possible, the rough-positioning guide means, which comprise, on the one hand, the bore 8 in the latching wedges 7 and, on the other hand, the guide rods 9, have to have a sufficiently large amount of guide play. At a diameter of a cylindrical guide rod 9 of 5 mm a diametrical guide play of approximately 0.2 mm, for example, is advantageous.

If, as the lock is being latched in place, there is an offset between the lock housing 1 and the latching housing 2 with respect to a central alignment, the latching wedges 7 are each inserted to a differing depth into the latching housing 2, as a result of which the desired tolerance compensation is achieved.

If there is an offset between the lock housing 1 and latching housing 2, the latching wedges 7 also bear, under the stress of spring force, against the bearing surfaces of the lock housing and latching housing in each case in a surface-locking and contacting manner. This results in exact fixing between the lock housing 1 and latching housing 2 in the lateral direction, i.e. transversely with respect to the latching direction. Thus, it is not possible for any rattling noises to occur within the lock during driving of the vehicle.

Located within the lock housing 1 is an introductory slot 12 via which the lock housing 1 is pushed onto the latching bracket 4 as the lock is being latched in place. This introductory slot 12 has at its front (as seen in the latching direction) a slot region 13 which tapers rearwards and which is adjoined by a narrowest region 14 having a certain length where the slot width is identical. This narrowest slot region 14 is then followed by an end slot region 15 which widens again. The narrowest gap region 14 facilitates centering with respect to the latching housing 2 with the aid of the latching bracket 4, as the lock is being latched in place. When the lock is closed, the end gap region 15 ensures that the lateral guiding of the lock housing 1 within the latching housing 2 is achieved solely by the lateral latching wedges 7. The latter may, for example, be made of plastic, while the remaining lock parts above generally consist of metal.

The lock may be fitted in its entirety to the vehicle with the latching housing 2 open, so that adjustment on the lock can be carried out in a simple manner. The latching housing can be closed by a plastic cover 16 which can be snapped on, for example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle lock mechanism having a latching housing which is mountable to a support or to the body of the vehicle in a variable position and a lock housing which can be introduced into the latching housing, wherein:
a rotary latch is mounted in the lock housing;
the latching housing is provided with an interior space for accommodating the lock housing, said interior space having side walls;
when the lock is closed, the lock housing lies within the interior space of the latching housing, with the rotary latch secured against an abutment of the latching housing;
the lock housing tapers trapezoidally in a pivoting plane of the rotary latch, becoming progressively narrower in the latching direction, towards the latching housing;
within the latching housing, sliding wedges which are resiliently displaceable in the latching direction on guide means, and have tapered edges with a wedge angle corresponding to a slope of tapered edges of the lock housing, are assigned to each of said two tapered edges of the lock housing, the spring force acting counter to the latching direction;
the guide means comprise rough- and fine-positioning guide means;
the rough-positioning guide means comprises a bore extending in the latching direction within each latching wedge, and an associated guide rod which engages axially in the said bore and is fastened rigidly to the latching housing, with guide play between the bore and the associated guide rod;
the fine-positioning guide means in each case comprises a planar, inner guide surface of a side wall of the latching housing and a planar side surface of an associated latching wedge; and
when the lock is closed, an amount of guide play in the rough-positioning guide means allows lateral positional fixing of the latching wedges between the lock housing and the latching housing solely by means of the fine-positioning guide means.

2. The vehicle lock according to claim 1, wherein the latching housing comprises at least one baseplate with side walls forming parts of the fine-positioning guide means.

3. The vehicle lock according to claim 1, wherein the abutment is fastened solely on the baseplate of the latching housing.

4. The vehicle lock according to claim 3, wherein the abutment is designed as a U-shaped latching bracket with the ends of the U limbs fastened to a baseplate.

5. The vehicle lock according to claim 1, wherein the latching housing comprises a baseplate and a covering which can be fitted releasably to the latter and encloses the latching wedges.

6. The vehicle lock according to claim 1, wherein:
the lock housing has an introductory slot which encloses the abutment of the latching housing in the pivoting plane of the rotary latch laterally with respect to the latching direction;
the introductory slot has a region with a narrowest slot portion lying between its start and end; and
during latching of the lock, the abutment of the latching housing passes through the portion with the narrowest slot width.

7. A vehicle lock comprising:
a latch housing which is fixedly mountable at a variable location on a vehicle body or on a support member thereon;
a lock housing which is mountable to a movable member that is to be locked to said vehicle body, said lock housing being insertable in a latching direction into a locked position in said latch housing, and having an approximately trapezoidal shape with tapered lateral edges which define a progressively narrow transverse dimension in the latching direction;
a rotary latch mounted in said lock housing for engaging with a latching bracket mounted in said latch housing;
a pair of wedge shaped guide elements within said latch housing, each having a planar guiding surface disposed opposite an inclined surface thereof, said inclined surface being inclined at an angle that corresponds inversely to an inclination angle of the tapered lateral edges of the lock housing, said pair of guide elements being disposed at lateral sides of the latch housing, whereby the inclined surfaces of the guide elements engage with the tapered lateral edges of the lock housing as it is inserted into the latch housing;
a pair of bores extending in the latching direction, one within each of said guide elements; and
a pair of guide rods which engage axially in each of said bores, respectively, and resiliently support said guide elements against movement in the latching direction;
wherein an amount of lateral play between said guide rods and said bores allows lateral movement of said guide elements, so that said guiding surfaces move into contact with planar lateral interior surfaces of said latch housing as said lock housing is inserted into the latch housing in the latching direction.
